(19) United States
(12) Patent Application Publication
(10) Pub. No.: US 2003/0061717 A1
(43) Pub. Date: Apr. 3, 2003

(54) Spiral cutting tool and method for fabricating same

(76) Inventor: Pei-Yuan Lee, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/106,535

(22) Filed: Mar. 26, 2002

(30) Foreign Application Priority Data
Sep. 28, 2001 (TW) 0909124173

(51) Int. Cl. B26B 3/00

(52) U.S. Cl. 30/304; 30/307

(57) ABSTRACT

A spiral cutting tool applied in a shredder and a method for fabricating the spiral cutting tool are disclosed. The spiral cutting tool includes an axle and plural round blades, each of which has a first engaging hole and a first piercing element, wherein the plural round blades fixed to the axle by engagements of the first engaging holes and the axle, and the first piercing elements of every adjacent two blades have angles of difference at the same value.

### FIELD OF THE INVENTION

The present invention is related to a spiral cutting tool and a method for fabricating the tool, and more particularly, to a spiral cutting tool and method for fabricating the tool providing an axle and plural round blades to be applied in a shredder.

### BACKGROUND OF THE INVENTION

A shredder is an indispensable machine in the office. Referring to FIG. 1, the shredder comprises two opposite cutting tools, shown as 1 and 2, wherein plural blades 12 are fixed in an axle 11 and every adjacent two of plural blades 12 have a gap 13 for disposing a respective one of plural blades 22 of the cutting tool 2. Furthermore referring to FIG. 2, the shredder provides a spiral cutting tool formed with piercing elements 23, 24 for reducing the necessary demand of the twisting force while the shredder is working, and thereby the cutting ability of the shredder can be improved. However, the method of the prior art to fabricate the spiral cutting tool comprises steps of providing a whole cutting tool by a die first and then obtaining piercing elements 23, 24 disposed on the whole cutting tool spirally by cutting. Furthermore, those foregoing steps are hard to proceed and the procedure must have a relatively high cost. For the above reasons, it is desirable to develop a low-cost and effective method for fabricating the cutting tool.

### SUMMARY OF THE INVENTION

It is one object of the present invention to provide a spiral cutting tool and a method for fabricating the tool, which is simple in structure and inexpensive to manufacture.

It is another object of the present invention to provide a spiral cutting tool and a method of manufacturing the cutting tool providing an axle and plural round blades to be applied in a shredder.

According to the present invention, a method for fabricating a spiral cutting tool applied in a shredder comprises steps of providing an axle, providing plural round blades, each of which has a first engaging hole and a first piercing element, and fixing the plurality of round blades to the axle by engagements of those first engaging holes and the axle, wherein first piercing elements of every adjacent two blades have angles of difference at the same value.

Certainly, the method can further comprise steps of providing plural spacers, each of which has a second engaging hole; and fixing each of spacers around the axle through the second engaging hole between respective adjacent round blades to obtain the same gap.

Preferably, each of the round blades has a second piercing element disposed at a position diametrically opposite to the first piercing element thereof.

Preferably, those first piercing elements of every two adjacent blades have angles of difference at 6.4°.

Preferably, each of those round blades has a first part and a second part in similar shapes, and those piercing elements of those first parts are longer than those of those second parts.

According to the present invention, a spiral cutting tool applied in a shredder comprises an axle, plural round blades, each of which has a first engaging hole and a first piercing element, wherein the plural round blades fixed to the axle by engagements of those first engaging holes and the axle, and those first piercing elements of every adjacent two blades have angles of difference at the same value.

Certainly, the spiral cutting tool can further comprise plural spacers, each of which has a second engaging hole, wherein each of these spacers is fixed around the axle through the second engaging hole between two respective adjacent round blades to obtain the same gap.

Preferably, each of the round blades has second piercing element disposed at a position diametrically opposite to the first piercing element thereof.

Preferably, those first piercing elements of every adjacent two blades have angles of difference at 6.4°.

Preferably, each of these round blades has a first part and a second part in similar shapes, and the piercing elements of the first parts are longer than those of the second parts.

Now the foregoing and other features and advantages of the present invention will be more clearly understood through the following descriptions with reference to the drawings, wherein:

### BRIEF DESCRIPTION OF THE DRAWINGS

FIG. 1 schematically depicts cutting tools of the prior art shredder;

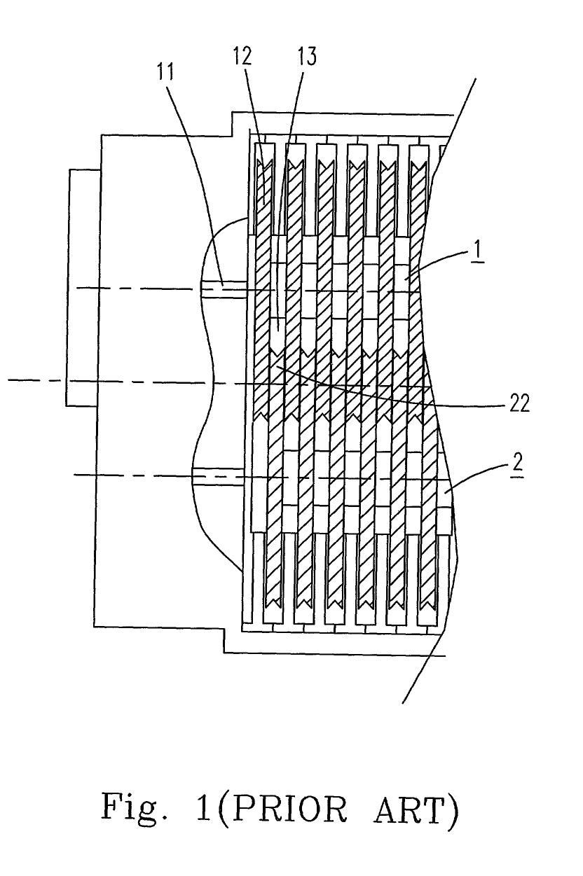

FIG. 2 illustrates a whole cutting tool of the prior art shredder;

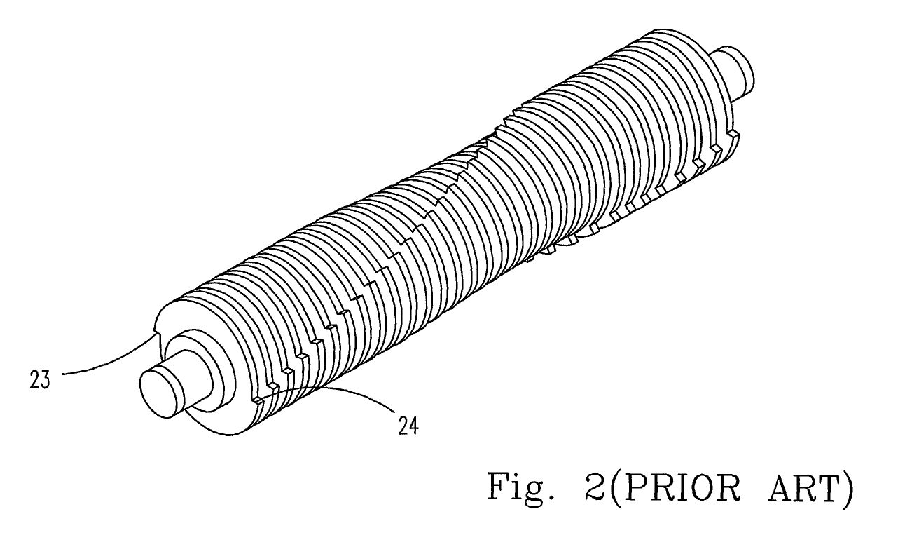

FIG. 3 is an exploded perspective view of a spiral cutting tool according to the present invention; and

FIG. 4 is an assembled perspective view of the spiral cutting tool shown in FIG. 3.

### DETAILED DESCRIPTION OF THE PREFERRED EMBODIMENT

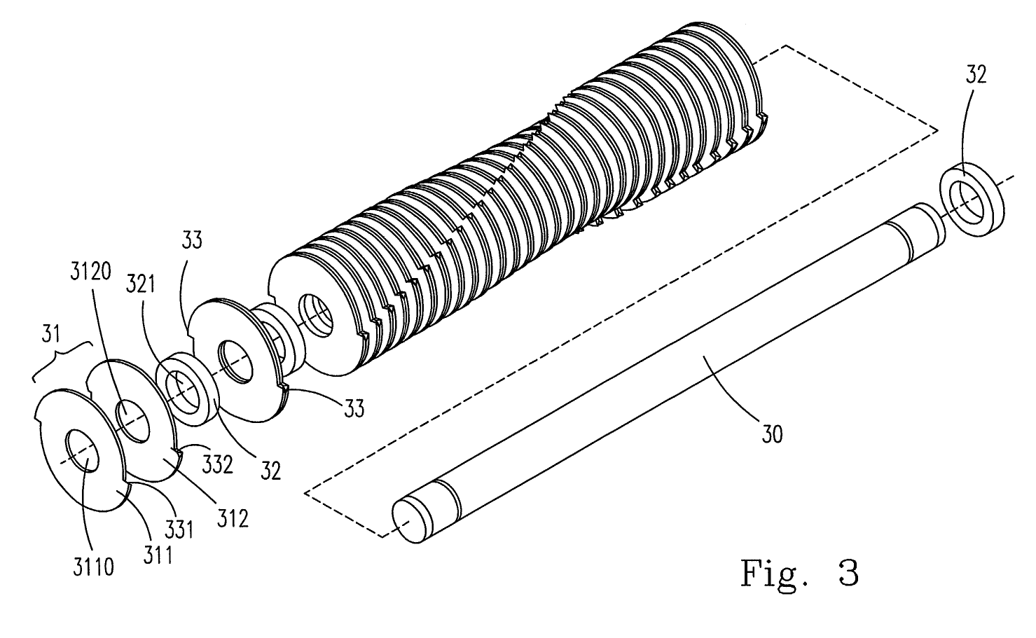

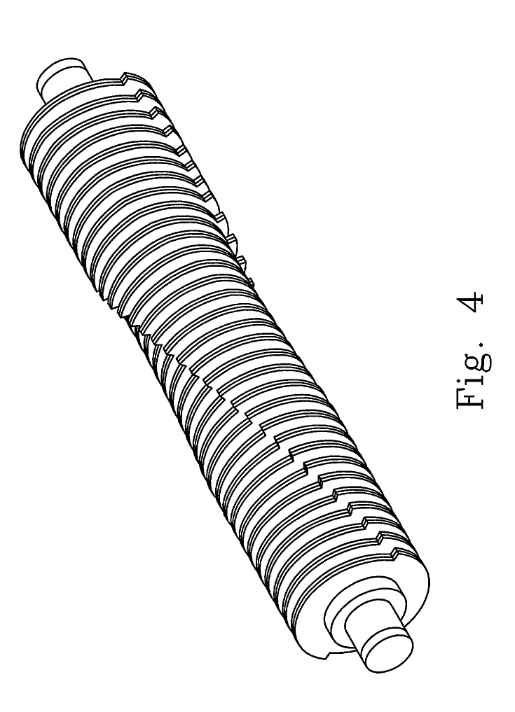

Referring to FIG. 3, a spiral cutting tool according to the present invention basically comprises an axle 30, plural round blades 31, and plural spacers 32, wherein each of round blades 31 has a first part 311 and a second part 312, and each of spacers 32 has an engaging hole 321. The first part 311 and the second part 312 are in similar shapes and the piercing part 331 of the first part 311 is longer than the piercing part 332 of the second part 312. The first part 311, the second part 312 and the spacer 32 are fixed to the axle 30 respectively by engagements of these first engaging holes 3110, these second engaging holes 3120, these engaging holes 321 and the axle 30. Repeating the foregoing step, a spiral cutting tool is formed afterward, wherein those first piercing elements 33 of every two adjacent blades 31 have angles of difference at the same value. FIG. 4 is an assembled perspective view of the spiral cutting tool according to the present invention. It is convenient for assembling the spiral cutting tool by marking respectively on the periphery of each of these first engaging holes 3110 and these second engaging holes 3120 while these first parts 311 and these second parts 312 are manufactured. If a spiral cutting tool whose first piercing elements 33 of every two adjacent blades 31 have angles of difference at 6.4°, there must be 28 marks on these round blades 31, wherein each mark of each of blades 31 including these first parts 311 and these second parts 312 has an index for alignment and a different serial number for sequential arrangement. When one assembles the spiral cutting tool, it is easy to assemble according to indexes and serial numbers of assembled blades 31. FIG. 4 is an assembled perspective view of the spiral cutting tool. However, the method of the prior art to fabricate the spiral cutting tool comprises steps of providing a whole cutting tool by a die first and then obtaining piercing elements disposed on the whole cutting tool spirally by cutting. Those prior steps are hard to proceed and the procedure must have a relatively high cost. On the other hand, the piercing part 331 of the first part 311 is longer than the piercing part 332 of the second part 312 and each of round blades 31 comprises the first part 311 and the second part 312. The novel piercing elements can reduce the required twisting force effectively while the shredder is working. The prior art, however, fails to teach, suggest or hint to obtain the same piercing element by steps of a die and cutting. Accordingly, those prior piercing elements by cutting can not reach the same effects as those of the present invention.

Hence, the spiral cutting tool assembled according to the present invention can provide a low-cost and effective method for fabricating the cutting tool. It is appreciated from the preceding descriptive explanations of preferred embodiments that the spiral cutting tool according to the present invention provides simplified component parts to make the assembly job be accomplished in a fast manner so as to lower down the production cost greatly.

Although the present invention has been described and illustrated in detail, it is to be clearly understood that the same is by the way of illustration and example only and is not to be taken by way of limitation, the spirit and scope of the present invention being limited only by the terms of the appended claims.

What is claimed is:

1. A method for fabricating a spiral cutting tool applied in a shredder comprising steps of:
providing an axle;
providing plural round blades, each of which has a first engaging hole and a first piercing element; and
fixing said plurality of round blades to said axle by engagements of said first engaging holes and said axle, wherein said first piercing elements of every adjacent two blades have angles of difference at the same value.

2. The method according to claim 1, further comprising steps of:
providing plural spacers, each of which has a second engaging hole; and
fixing each of said spacers around said axle through said second engaging hole between two respective adjacent round blades to obtain the same gap.

3. The method according to claim 1, wherein each of said round blades has a second piercing element disposed at a position diametrically opposite to said first piercing element thereof.

4. The method according to claim 1, wherein said first piercing elements of every two adjacent blades have angles of difference at 6.4°.

5. The method according to claim 1, wherein each of said round blades has a first part and a second part in similar shapes, and said piercing elements of said first parts are longer than those of said second parts.

6. A spiral cutting tool applied in a shredder comprising:
an axle;
plural round blades, each of which has a first engaging hole and a first piercing element, wherein said plural round blades fixed to said axle by engagements of said first engaging holes and said axle, and said first piercing elements of every adjacent two blades have angles of difference at the same value.

7. The spiral cutting tool according to claim 6, further comprising:
plural spacers, each of which has a second engaging hole, wherein each of said spacers is fixed around said axle through said second engaging hole between two respective adjacent round blades to obtain the same gap.

8. The spiral cutting tool according to claim 6, wherein each of said round blades has a second piercing element disposed at a position diametrically opposite to said first piercing element thereof.

9. The spiral cutting tool according to claim 6, wherein said first piercing elements of every adjacent two blades have angles of difference at 6.4°.

10. The spiral cutting tool according to claim 6, wherein each of said round blades has a first part and a second part in similar shapes, and said piercing elements of said first parts are longer than those of said second parts.
